(19) United States
(12) Patent Application Publication
(10) Pub. No.: US 2009/0056771 A1
(43) Pub. Date: Mar. 5, 2009

(54) WATER RECOVERY ASSEMBLY

(75) Inventors: Christian Kmet, New South Wales (AU); Paul Aerlic, New South Wales (AU); Paul McNeill, New South Wales (AU)

Correspondence Address: Fay Sharpe LLP, 1228 Euclid Avenue, 5th Floor, The Halle Building, Cleveland, OH, 44115-1843, US

(73) Assignee: FULLBUCKETOFWATER PTY LTD, Botany (AU)

(21) Appl. No.: 12/278,656

(22) PCT Filed: Oct. 16, 2007
(86) PCT No.: PCT/AU2007/001568

§ 371 Date: Aug. 7, 2008

(30) Foreign Application Priority Data
Oct. 18, 2006 (AU) 2006905837

(51) Int. Cl. B08B 3/02

(52) U.S. Cl. 134/110

(57) ABSTRACT

An assembly (10) to aid in cleaning a boat that is located on a boat trailer. The assembly (10) includes a trailer (11) that has a number of tanks (12, 13, 14), as well as pumps. The boat and its associated trailer is parked on a water collection facility (17) that includes a sheet (23) that drains water to a location for delivery to the tanks, and a mat (18) located beneath the sheet (23).

### TECHNICAL FIELD

The present invention relates to a water recovery assembly to aid in reusing water that has been used in cleaning objects, and more particularly but not exclusively to a water recovery system to be employed with the cleaning of marine vessels.

### BACKGROUND OF THE INVENTION

Marine vessels require frequent cleaning, this includes boats that are transported by means of trailers. When removed from a water way these boats need to be cleaned including flushing of the engine and cleaning of any under floor cavities of the vessel.

With water restrictions, cleaning as discussed above is not permissible using mains water supplies.

A further problem is the water discarded after cleaning. This can frequently pose a pollution problem.

### OBJECT OF THE INVENTION

It is the object of the present invention to overcome or substantially ameliorate at least one of the discussed problems.

### SUMMARY OF THE INVENTION

There is disclosed herein an assembly to aid in cleaning a mobile item, said assembly including:

a tank to receive a liquid that is to be used to clean the item;

a liquid collection facility upon which the item is to rest to collect liquid used in cleaning the item;

a filter via which the liquid passes to be returned to the tank;

a first pump, said first pump being connected to said facility and said filter to return the liquid from said facility to said filter;

a second pump, said second pump being connected to said tank to draw the liquid therefrom and to provide liquid under pressure for the purposes of cleaning said item; and wherein

said facility includes a sheet of flexible material having a periphery and upon which the item is to be placed, an inflatable means attached to the sheet to raise the periphery thereof to aid in draining the liquid to a location from where the liquid it is collected for delivery to the first pump.

Preferably, said inflatable means is a tube adjacent said periphery.

Preferably, said tube is provided to rest upon a surface, with said sheet extending from said tube at a position above said surface.

Preferably, said tube is “U-shaped” in configuration so as to at least partly surround said sheet.

Preferably, said assembly includes a mat located below said sheet and also attached to said tube.

Preferably, said assembly includes a duct extending from said sheet to said first pump.

Preferably, said tank is a first tank, and said first pump takes the liquid from said first tank to deliver the liquid to said filter, and said assembly includes a second tank to which water from said filter is delivered, and a third tank that receives liquid from said second tank and from which said second pump draws liquid.

Preferably, said assembly includes a third pump, said third pump taking liquid from said third tank and delivering the liquid to a hose to be used in cleaning said item.

Preferably, said assembly includes a fourth pump, said fourth pump taking liquid from said second tank and delivering it to said third tank, and a float switch operatively associated with said third tank to detect liquid level therein and to operate said fourth pump.

### BRIEF DESCRIPTION OF THE DRAWINGS

A preferred form of the present invention will now be described by way of example with reference to the accompanying drawings wherein:

FIG. 1 is a schematic top plan view of a trailer having a series of pumps and tanks forming part of an assembly to aid in cleaning a boat located on a trailer;

FIG. 2 is a schematic top plan view of a water collection facility to be used with the trailer of FIG. 1; and

FIG. 3 is a schematic section end elevation of the facility of FIG. 2 sectioned along the line 3-3.

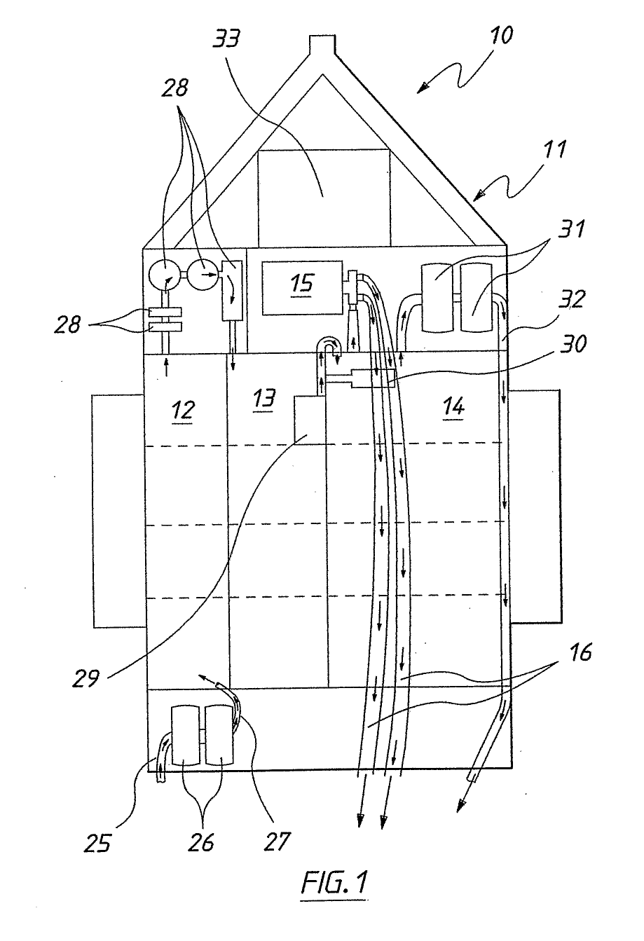

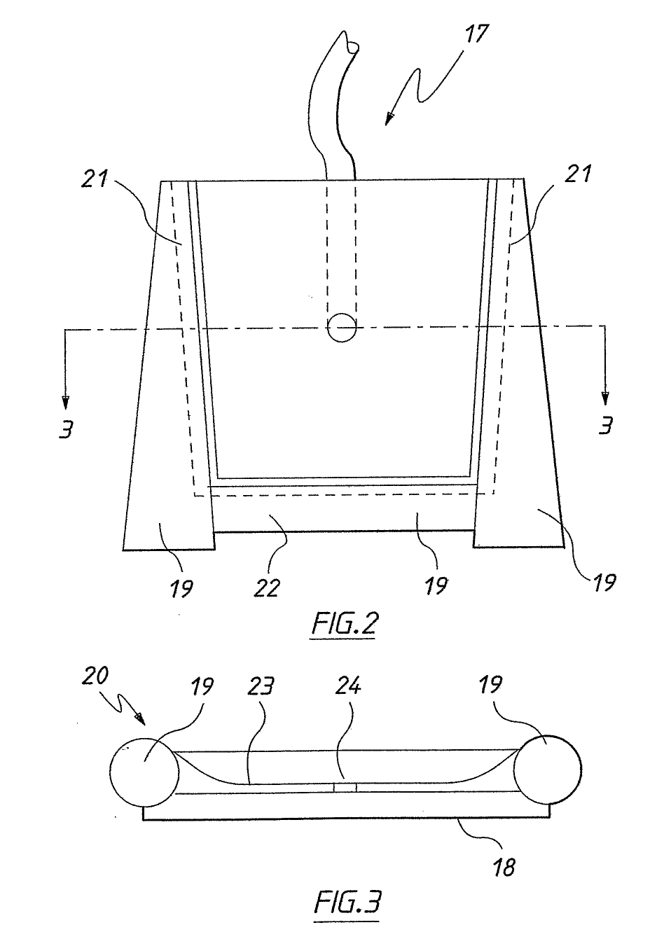

### DETAILED DESCRIPTION OF THE PREFERRED EMBODIMENT

In the accompanying drawings there is schematically depicted an assembly 10 to aid in cleaning a boat that is located on a boat trailer. The assembly 10 includes an assembly trailer 11 upon which there is mounted three tanks, 12, 13 and 14. Taking water from the third tank 14 is a pump and motor assembly 15 that delivers water under pressure to one or more hoses 16. The hoses 16 provide water under pressure that is used to clean the boat.

The boat on its associated trailer is parked on a water collection facility 17. The facility 17 includes a mat 18 of sheet plastics material to which there is attached an inflatable means 20 in the form of a tube 19. The tube 19 is of a U-shaped configuration so as to have two longitudinal side tube portions 21 and an end portion 22. The tube 19 extends upwardly from the mat 18 and has fixed to it a water collection sheet 23. More particularly the sheet 23 is attached to the tube 19 at a position higher than the mat 18 so that the sheet 23 forms a trough. The sheet 23 is preferably sheet plastics material.

When the trailer with its boat mounted thereon is located on the facility 17 so that the sheet 23 is located therebeneath, the sheet 23 will naturally form a recess to which water will drain. Extending from this recess is a drain 24 to which a hose 25 is attached.

Water collected by the facility 17 is delivered to the tube 25, which in turn delivers water to a pump and motor assembly 26. The assembly 26 delivers water to the tank 12 by means of a duct 27.

Taking water from the tank 12 is a motor and pump assembly 28 that delivers water under pressure to the filters 28 from where water is returned to the tank 13.

Submerged in the tank 13 is a pump and motor assembly 29 that is operated by means of a float switch 30. The pump 29 when operated by the float switch 30 delivers water to the tank 14.

Also taking water from the tank 14 is a further pump and motor assembly 31 that delivers water under pressure to a hose 32.

Preferably the motor and pump assembly 15 provides water under high pressure for cleaning purposes. The motor and pump assembly 31 would provide high volume flow for the purposes of flushing the engine and/or other portions of the boat.

Preferably the trailer 11 is provided with a power supply assembly 33 that would include an electric generator driven by an internal combustion engine.

1. An assembly to aid in cleaning a mobile item, said assembly including:
a tank to receive a liquid that is to be used to clean the item;
a liquid collection facility upon which the item is to rest to collect liquid used in cleaning the item;
a filter via which the liquid passes to be returned to the tank;
a first pump, said first pump being connected to said facility and said filter to return the liquid from said facility to said filter;
a second pump, said second pump being connected to said tank to draw the liquid therefrom and to provide liquid under pressure for the purposes of cleaning said item; and wherein
said facility includes a sheet of flexible material having a periphery and upon which the item is to be placed, an inflatable means attached to the sheet to raise the periphery thereof to aid in draining the liquid to a location from where the liquid it is collected for delivery to the first pump.

2. The assembly of claim 1, wherein said inflatable means is a tube adjacent said periphery.

3. The assembly of claim 2, wherein said tube is provided to rest upon a surface, with said sheet extending from said tube at a position above said surface.

4. The assembly of claim 3, wherein said tube is “U-shaped” in configuration so as to at least partly surround said sheet.

5. The assembly of claim 4, further including a mat located below said sheet and also attached to said tube.

6. The assembly of claim 5, further including a duct extending from said sheet to said first pump.

7. The assembly of claim 6, wherein said tank is a first tank, and said first pump takes the liquid from said first tank to deliver the liquid to said filter, and said assembly includes a second tank to which water from said filter is delivered, and a third tank that receives liquid from said second tank and from which said second pump draws liquid.

8. The assembly of claims 1 to 7, further including a third pump, said third pump taking liquid from said third tank and delivering the liquid to a hose to be used in cleaning said item.

9. The assembly of claim 8, further including a fourth pump, said fourth pump taking liquid from said second tank and delivering it to said third tank, and a float switch operatively associated with said third tank to detect liquid level therein and to operate said fourth pump.

10. The assembly of claim 2, wherein said tube is “U-shaped” in configuration so as to at least partly surround said sheet.

11. The assembly of claim 2, further including a mat located below said sheet and also attached to said tube.

12. The assembly of claim 1, further including a duct extending from said sheet to said first pump.

13. The assembly of claim 1, wherein said tank is a first tank, and said first pump takes the liquid from said first tank to deliver the liquid to said filter, and said assembly includes a second tank to which water from said filter is delivered, and a third tank that receives liquid from said second tank and from which said second pump draws liquid.

14. The assembly of claim 13, further including a third pump, said third pump taking liquid from said third tank and delivering the liquid to a hose to be used in cleaning said item.

15. The assembly of claim 14, further including a fourth pump, said fourth pump taking liquid from said second tank and delivering it to said third tank, and a float switch operatively associated with said third tank to detect liquid level therein and to operate said fourth pump.
